(19) United States
(12) Patent Application Publication
(10) Pub. No.: US 2009/0315319 A1
(43) Pub. Date: Dec. 24, 2009

(54) SECURITY DOCUMENTS AND METHODS OF DETERRING COUNTERFEITING

(76) Inventors: Jimmy Kendrick, Nacogdoches, TX (US); Larry McCartney, Buckhannon, WV (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/495,524

(22) Filed: Jun. 30, 2009

Related U.S. Application Data
(63) Continuation-in-part of application No. 11/877,162, filed on Oct. 23, 2007.
Application No. 11/877,162 is a continuation-in-part of application No. 11/778,942, filed on Jul. 17, 2007.

(51) Int. Cl. B42D 15/10

(52) U.S. Cl. 283/93; 283/85

(57) ABSTRACT

Apparatus and methods are described for a security document comprising a border formed at least partially by a plurality of microprint characters. At least a portion of the microprint characters are arranged in a curvilinear pattern, and at least a portion of the microprint characters are not substantially reproducible via a digital imaging device.

### RELATED APPLICATION

This patent is a continuation-in-part of U.S. patent application Ser. No. 11/877,162, filed on Oct. 23, 2007, and U.S. patent application Ser. No. 11/778,942, filed on Jul. 17, 2007, which are hereby incorporated herein by reference in their entireties.

### FIELD OF DISCLOSURE

The present disclosure is generally directed to documents and, more particularly, to security documents and methods of deterring counterfeiting.

### BACKGROUND

Many techniques exist to deter counterfeiters from attempting to copy important documents such as currency, checks, credit cards, passports, government documentation, and fiduciary records. As technology advances, digital imaging devices (e.g., photocopiers) become more sophisticated at producing seemingly genuine recreations of important or otherwise valuable documents. Thus, there have been many attempts at securing documents from counterfeiters.

For example, in U.S. Pat. No. 4,891,666, a pattern is provided on a document that masks a copy indicator (e.g., the word “VOID”). When an attempt is made to copy a document with this pattern and copy indicator, the resolution of the copy indicator in the copy is greater than the pattern and, thus, the copy indicator is clearly visible in the produced copy.

Another example technique to deter document counterfeiting is described in U.S. Pat. No. 5,443,579. This patent describes combining various levels of raised print and colors that are the same or similar to the background substrate to create latent images that may only be visible when the document is held at a certain angle. However, in both the above-described known techniques, the security feature is not readily viewable to a person's unaided eyes. Consequently, it is not readily known that a document is secure without attempting to copy the document or otherwise manipulating the document.

U.S. Pat. No. 5,772,249 describes another technique for securing documents that includes moiré fringes and the creation of lines of varying width spaced at varying distances controlled by various complex ratios. U.S. Pat. Nos. 6,089,614 and 6,997,482 also describe other complex techniques for securing a document against counterfeiting that include complicated and intricate printing patterns on both first and second sides of the substrate of the document to be secured.

### BRIEF DESCRIPTION OF THE DRAWINGS

FIG. 1 depicts an example document having an example anti-counterfeiting feature.

FIG. 2 is an enlarged view of a portion of the example security document of FIG. 1 showing an example anti-counterfeiting feature.

FIG. 3 is an enlarged view of another portion of the example security document of FIG. 1 showing another example anti-counterfeiting feature.

FIG. 4 is a flow diagram of an example process for production of a security document with anti-counterfeiting features that may be implemented to produce the example document of FIG. 1.

FIGS. 5-7 are enlarged portions of alternative example security documents containing alternative example counterfeiting features.

FIG. 8 shows an enlarged portion of the security document of FIG. 7 after an attempt to remove post-printing.

FIG. 9 depicts another example document having alternative example anti-counterfeiting features.

FIG. 10 is an enlarged view of a portion of the document of FIG. 9.

FIG. 11 is an enlarged view of a portion of the view of FIG. 10.

FIG. 12 depict a portion of another example border including an example latent letter.

### DETAILED DESCRIPTION

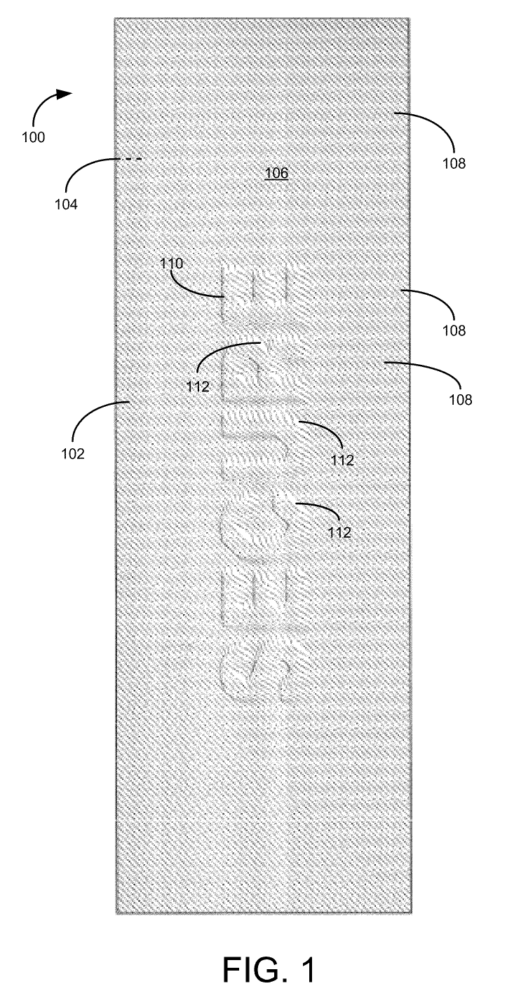

FIGS. 1 through 3 show an example security document 100 that includes an area of microprinting including a pattern of microprint. The example security document 100 also includes a three-dimensional appearing image, wherein the three-dimensional appearing image is formed within the area of microprinting by one or more departures from the pattern of microprint. The area of microprinting and the three-dimensional appearing image are not substantially reproducible via a digital imaging device.

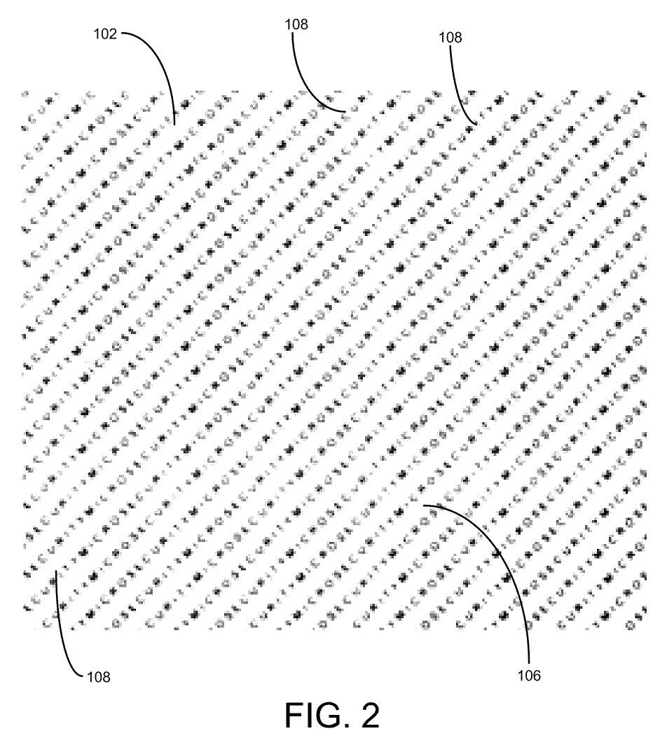

Specifically, the example security document 100 of FIG. 1 includes a front face 102 and a back face 104. In the illustrated example, the front face 102 contains a pantograph that is an area of microprinting 106 including microtext or microcharacters, i.e. microprint 108, over substantially the entire front face 102. FIG. 2 shows the area of microprinting 106 enlarged with the microprint 108 shown in greater clarity. In the example shown, the term “microsecurity” appears in the microprint 108, but any other word in any language, any symbol, any shape or any image may be used in addition to or instead of the term “microsecurity.” Furthermore, the microprint 108 may be customized to, for example, meet the requirements and/or desires of one or more customers. For example, one customer may want one or more customized words to appear as the microprint 108 while another customer may want a coded serial number, etc. In other examples, the area of microprinting 106 may appear across substantially the entire back face 104, smaller portions of the front face 102 or the back face 104, in multiple areas on the front face 102 or the back face 104, or any combination thereof.

As shown in FIGS. 1 and 2, portions of the area of microprint 106 appear as a regular pattern of microprint 108 on the background of the security document 100. With the naked eye or unaided eye, the microprint 108 may appear as lines. However, with the aid of a magnification device, the microprint 108 is discernable and, if words, legible or readable. As used herein, the term “naked eye” refers to human visual perception that is unaided or otherwise unassisted by optical instruments that substantially alter the power of vision or substantially alter the apparent size or distance of objects such as, for example, binoculars, telescopes or magnifying glasses. The term is not meant to exclude aids typically worn by humans to correct their vision such as, for example, eyeglasses or contact lenses.

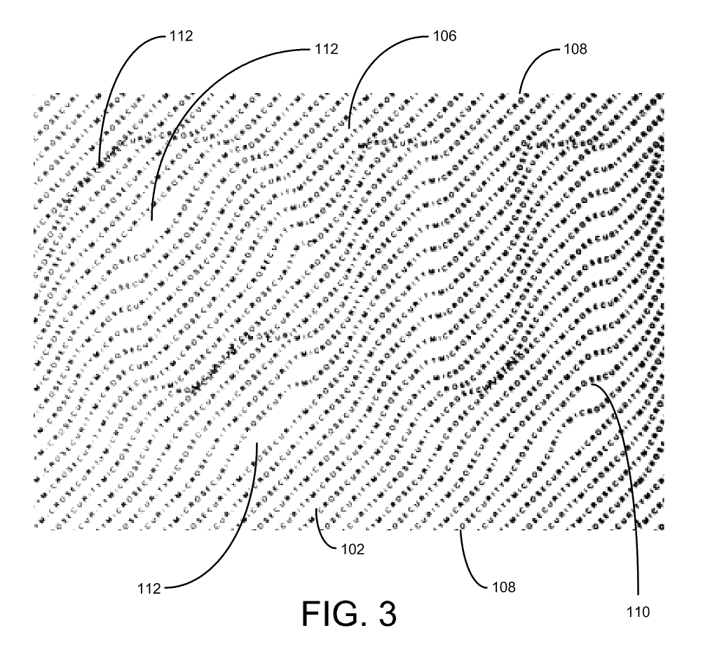

Within the area of microprinting 106 there is a three-dimensional appearing image or cue word 110 that is at least minimally visible to the naked eye. In other examples, the cue word 110 may be more or less overt, i.e., conspicuous or otherwise readily perceivable or visible such as, for example, visible with the naked eye. In the illustrated example, the cue word 110 is the word “secure.” However, any other word in any language, any symbol, any shape or any image may be used as well. Furthermore, the cue word 110 may be customized to be any logo, design, image or word(s). For example, the cue word 110 may be a multiple word phrase such as, for example, “Secured Document.” Additionally, or alternatively, the cue word 110 may appear repeatedly across or otherwise on the document 100. As shown in the illustrated example, the cue word 110 is formed in a portion of the area of microprinting 106 that has an irregular pattern, i.e., a portion of the area of microprinting 106 that includes deviations or departures 112 in the regular pattern of the microprint 108. For example, as shown in the figures and enlarged in FIG. 3, the microprint 108 appears largely or predominately in a pattern. In this example, the regular pattern is straight, parallel, diagonal lines that are equally spaced from one another. However, there are portions of the lines of the microprint 108 that are offset, deformed, curved relative to the regular pattern of the straight, diagonal lines to form an irregular pattern including the deviations or departures 112. Together, the deviations or departures 112 cause the cue word 110 to be perceived by a person's eyes as a three-dimensional appearing image. The deviations or departures 112 may be a convergence, divergence or any other deviation from the regular pattern of the microprint 108. In addition, in the illustrated example, the cue word 110 is formed using the same microprint 108 as the rest of the area of microprinting 106. However, in other examples, the cue word 110 may be formed using different microprint. In addition, the deviations or departures 112 cause the cue word 110 to be readily visible and, thus, the visibility of the cue word 110 is not dependent on the particular text used for the microprint 108.

The area of microprinting 106, the microprint 108 itself, and the cue word 110 are not substantially reproducible via a photocopier or any other digital imaging or optical reading device because, if copied, the microprint 108 is not effectively discernable in the copy. Therefore, if an attempt were made to copy a document that includes the area of microprint 106 and the cue word 110, neither the area of microprint 106 nor the cue word 110 would appear in the copy. Thus, a person handling or otherwise inspecting a copy of the security document 100 would be able to readily observe that both the area of microprint 106 and/or the cue word 110 are missing and, thus, the document must be a copy, an unauthorized version, a forgery, a counterfeit, or otherwise unofficial document.

In another example, the microprint 108 may not completely drop out when copied but may appear as a jagged, solid and/or broken line(s) and/or inconsistent in color. Thus, if the area of microprint 106 is inspected under magnification, a person would be able to readily determine if the document were authentic. The microprint 108 in original copied documents would be legible under magnification.

There are other aspects of the security document 100 that may vary between various examples or implementations of the security document 100. For example, the microprint 108 is of uniform size in the illustrated example. However, the microprint 108 may also vary in font style and size. Also, the microprint 108 in the illustrated example is English language, though any other language, real or imaginary, or symbols may be used additionally or alternatively.

In some examples, the microprint 108 may be printed using one or more colors or types of ink including pastel inks. Pastel inks include colors that are drop outs, which are not readily reproducible by some digital imaging and/or optical reading devices.

Furthermore, in some examples, the area of microprinting 106 may include one or more different densities. Different densities may be used to alter the ability of one or more portions of the area of microprinting 106 to be reproduced. For example, lighter densities may be used to enable a portion of the area of the microprint 106 to drop out when reproduction of the security document 100 is attempted.

As mentioned above, one or more of a variety of fonts and sizes may be used in the printing of the microprint 108. In the illustrated example, a non-serif, or sans-serif font is used. A sans-serif font lacks serifs, hinges or other ornamental features of a letter that may print improperly, irregularly, unevenly or otherwise inconsistently during the microprinting of the example security document 100. Furthermore, the example microprint 108 may be eleven decipoints or smaller. The microprint 108 font size should be large enough for printing, but small enough to not be visible to the unaided eye or readable and reproducible by a digital imaging device such as, for example, a scanner. Furthermore, the microprint 108 in the illustrated example is light. A light print does not create too dark of a background, is less likely to be readable and reproducible by a digital imaging device such as, for example, a copier, and may provide for a more aesthetically appealing background.

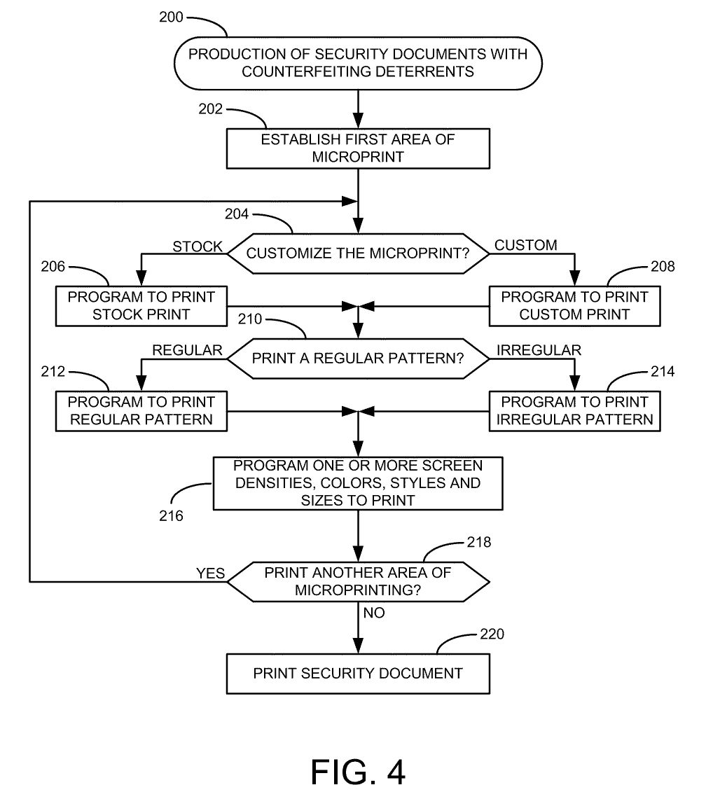

FIG. 4 depicts a flow diagram of an example process or method 200 that may used to produce a security document with counterfeiting deterrents, such as, for example, the example security document 100 of FIG. 1. In an example implementation, the operations depicted in the flow diagram of FIG. 4 may be implemented using machine readable instructions that are executed by any processing or computing systems now known or developed later. The machine readable instructions may be embodied in software stored on a tangible medium such as a CD-ROM, a floppy disk, a hard drive, a digital versatile disk (“DVD”), or a memory associated with a processor and/or embodied in firmware or dedicated hardware in a well-known manner. Further, although the example programs or processes are described with reference to the flow diagram illustrated in FIG. 4, persons of ordinary skill in the art will readily appreciate that many other methods of implementing the example document production process 200 may alternatively be used. For example, the order of execution of the blocks may be changed, and/or some of the blocks described may be changed, eliminated, or combined.

As stated above, the example process 200 of FIG. 4 may be used to produce a security document with counterfeiting deterrents. The example process 200 begins by setting up or establishing a first area of microprint to be printed (block 202), which may not be readily discernible with the naked eye but which may be legible under magnification. When setting up an area of microprint to be printed, the specific type of print is selected. For example, the print to be microprinted may be a custom print or a stock print (block 204). If the microprint is a stock print, the example process 200 is programmed to print the stock print (block 206). If the microprint is customized, any word, language, shape, symbol, etc. is programmed into the example process 200 to customize the print (block 208).

The example process 200 may also be programmed to print a regular and/or an irregular pattern (block 210). If a regular pattern is programmed, the example process 200 prints the regular program (block 212) (e.g., the pattern shown in FIG. 2). However, if an irregular pattern is programmed, the example process 200 prints an irregular pattern (block 214) (e.g., the pattern shown in FIG. 3). An irregular pattern may include any number and/or variety of deviations, convergences, divergences, deformations, offsets, or other departures from a regular, consistent pattern. In addition, as described above, an irregular pattern may be used to produce a three-dimensional appearing cue word or symbol (e.g., the cue word 110 shown in FIGS. 1 and 3), which may be visible to the naked eye.

The example process 200 may also include selection of one or more screen densities, ink colors, font style and sizes of the microprint (block 216). Further, the example process 200 may include one or more additional areas of microprint (block 218). If the example process 200 is programmed for printing an additional area of microprint, control is returned to block 204 and the parameters of the second area of microprinting are determined. The example process 200 may continue until a plurality of areas of microprinting is established. If an additional area of microprinting is not to be printed, the example process 200 continues to print the security document (block 220).

Security documents printed using the example process 200 (e.g., the security document 100) include counterfeiting deterrents such as, for example, the areas of microprint. If a security document printed from the example process 200 were copied or otherwise reproduced via a photocopier or other digital imaging or optical reading device, the area(s) of microprint would not be substantially reproduced. For example, the area(s) of microprint would appear as jagged, solid and/or broken line(s) or not appear at all. Thus, a person handling or otherwise inspecting a copy of the security document formed from the example process 200 would be able to readily observe that both the area(s) of microprint are blurred or missing and, thus, that the document must be a copy, an unauthorized version, a forgery, a counterfeit, or otherwise unofficial document.

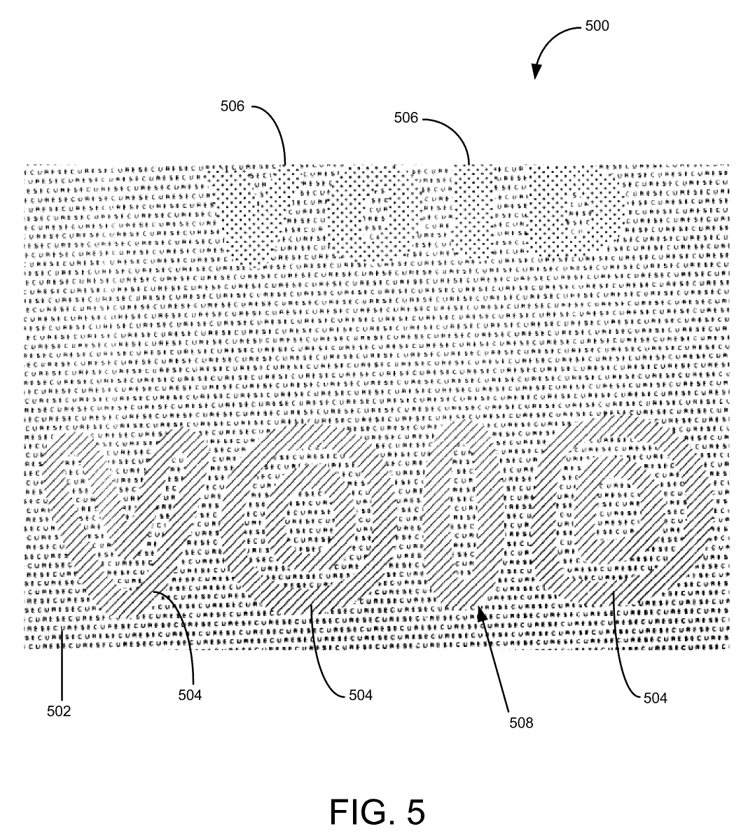

FIGS. 5-8 show enlarged portions of alternative example security documents containing alternative example counterfeiting features. Any or all of the security documents in FIGS. 5-8 may be combined with features (e.g., size, font, orientation, ink type, language choice, inclusion of three-dimensional images, conspicuousness, customization, etc.) of the security documents of FIGS. 1-3 and/or with other features of the security documents of FIGS. 5-8. In addition, any or any portion of any security document shown and discussed throughout this disclosure may be made using the example process 200 described in connection with FIG. 4.

FIG. 5 shows an enlarged portion of an example security document 500 that includes a first area of microprinting 502 and a plurality of second areas of microprinting 504. The first area of microprinting 502 includes a pattern of microprint in the form of text, and the second areas of microprinting 504 include a pattern of microprint in the form of diagonal lines. However, any aforementioned style or type of microprint may be used for either the first area of microprinting 502 or the second areas of microprinting 504. For example, the microprint may be a dotted pattern as shown in third areas of microprinting 506. Together the first area of microprinting 502 and the second areas of microprinting 504 form a latent image 508. In this example, the image 508 is the word “void” but any other word, symbol or character may be used instead. When not enlarged, the first area of microprinting 502 and the second areas of microprinting 504 form the background of the security document 500. The first area of microprinting 502 and the second areas of microprinting 504 may appear uniform. In other examples, the first area of microprinting 502 and the second areas of microprinting 504 are distinguishable. In all examples, the first area of microprinting 502 and the second areas of microprinting 504 are not substantially reproducible via a digital imaging device.

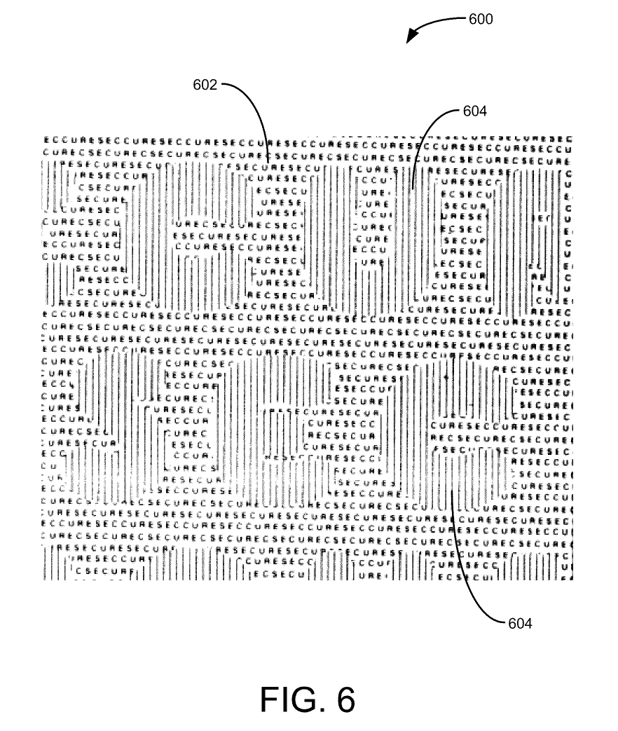

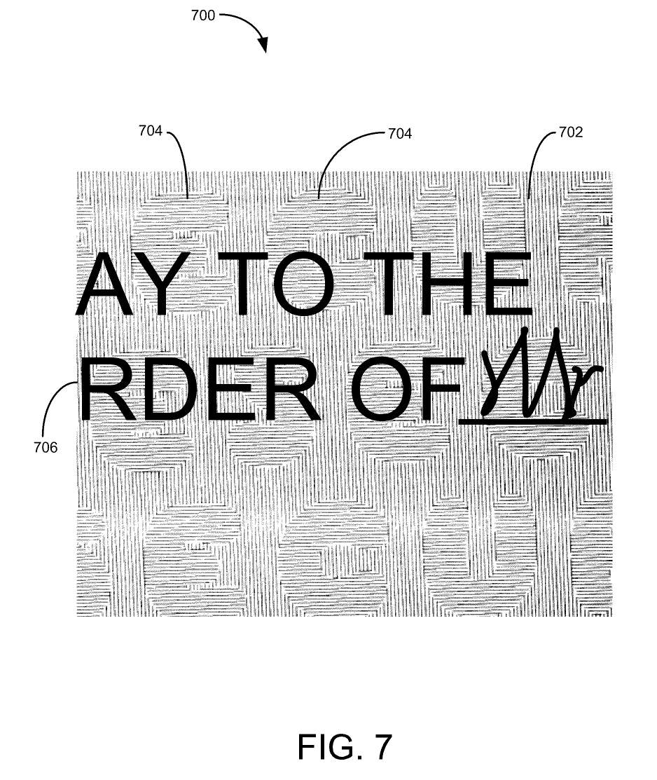

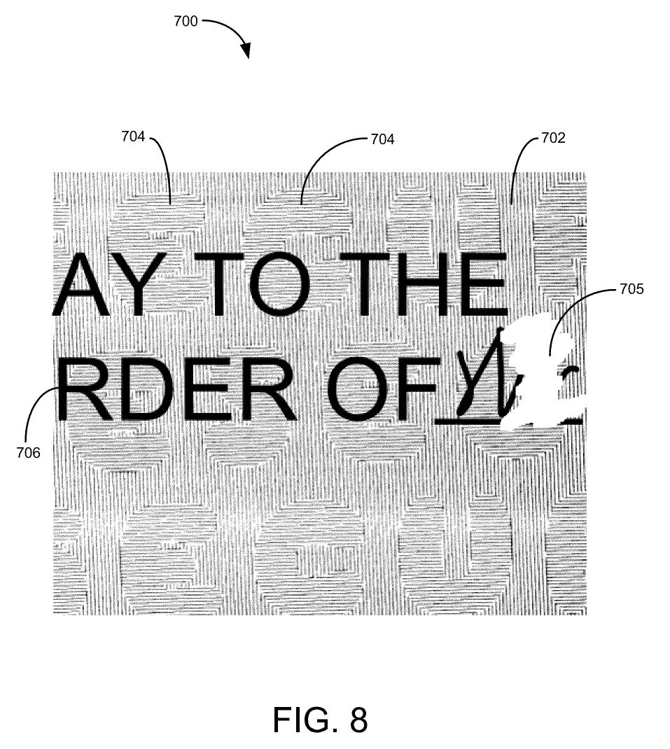

FIG. 6 shows an enlarged portion of another alternative example security document 600. The example security document 600 includes a first area of microprinting 602 and a second area of microprinting 604. The second area of microprinting 604 includes a pattern of vertical lines. The pattern of microprinting in the first area of microprinting 602 is substantially orthogonal to the pattern of microprinting in the second area of microprinting 604. Similarly, FIGS. 7 and 8 show an enlarged portion of yet another alternative example security document 700 that includes a pattern of microprinting in a first area of microprinting 702 that is substantially orthogonal to a pattern of microprinting in a second area of microprinting 704, where both patterns are lines.

The security document 700 also includes post-printing 706. The post-printing 706 in this example is a portion of writing from a check, though the post-printing may be any type of printing on any type of document. As shown in FIG. 8, when an attempt is made to alter the post-printing in the security document 700, the background, i.e., one or more of the first area of microprinting 702 and the second area of microprinting 704 are distorted (depending on where the attempt was made, in this example the attempt was made across both the first area of microprinting 702 and the second area of microprinting 704 in a distortion location 705). In addition, the distortion location 705 shown in FIG. 8 shows a complete removal of the first area of microprinting 702 and the second area of microprinting 704 along with the post-printing 706. In other examples, the distortion may be any other type of deformation or alteration including, for example, smudging, smearing, blurring or other disruption to the first area of microprinting 702 and/or the second area of microprinting 704.

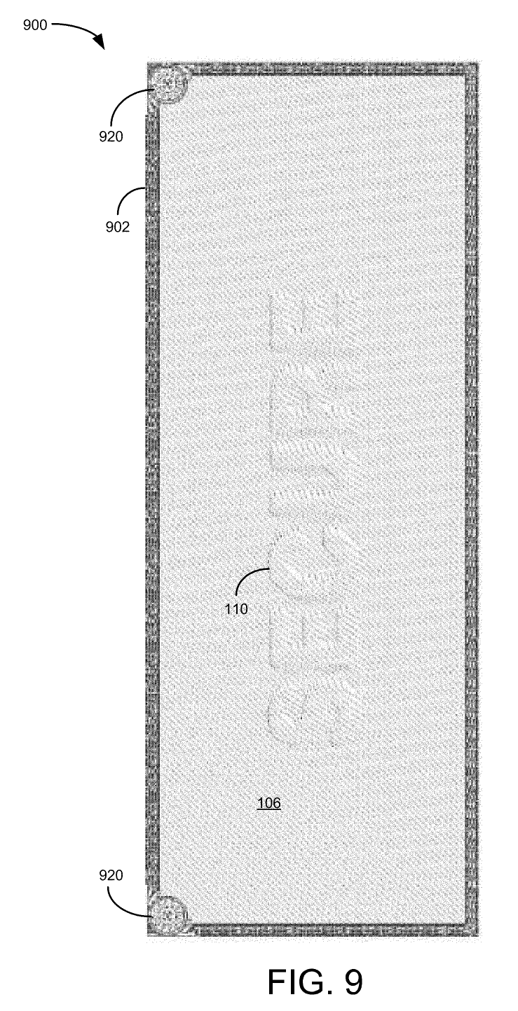

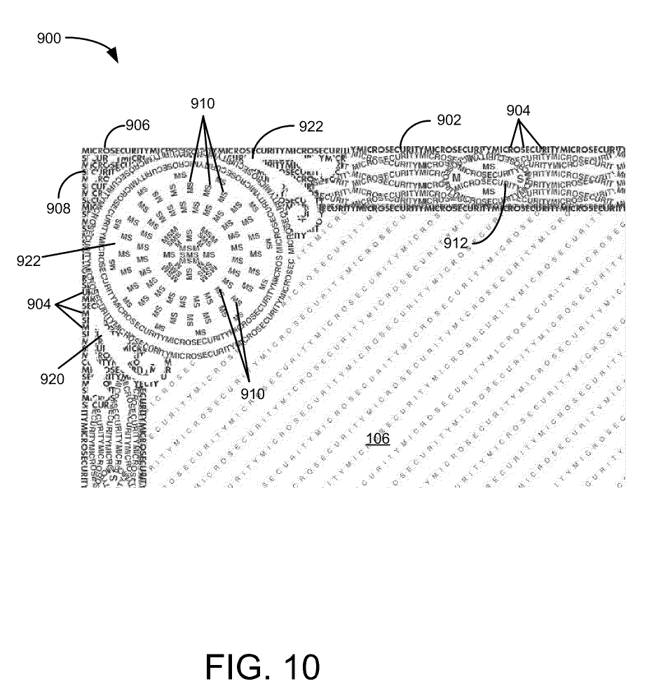

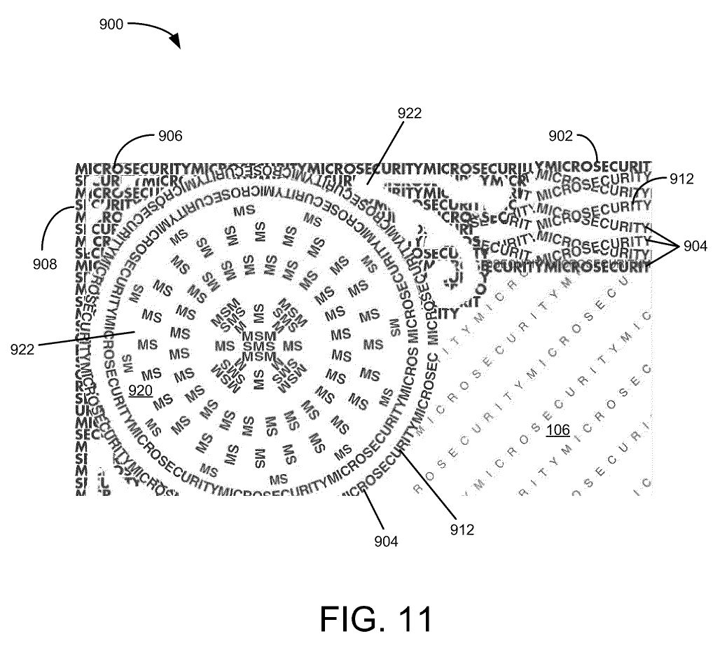

FIG. 9 shows another example security document 900 that includes a security border 902 having a plurality of microprint characters 904 as shown in the enlarged portions of the security border 902 in FIGS. 10 and 11. The microprint characters 904 may form a word, a string(s) of word(s), a partial word(s), a single letter(s), a number(s), a shape(s), a figure(s) and/or any combination thereof. Also, the example security document 900 may also include areas of microprint 106 and three-dimensional appearing images 110 as described above. As shown in FIG. 9, the areas of microprint 106 and three-dimensional appearing images 110 may not be fully legible when copied. FIGS. 10-12 show the document 900 under magnification in where the microprint may be readable. Furthermore, any feature of any example described herein may be combined with or used in place of any other feature of any example described herein.

As shown in FIGS. 10 and 11, the security border 902 includes a plurality of microprint characters 904 that are arranged in both horizontal and vertical linear patterns as shown along a top edge 906 and a side edge 908 of the security document 902. Furthermore, the microprint characters 904 may be arranged at any other angle as well as shown in the area labeled 910. In addition, the microprint characters 904 may be arranged at multiple angles or in a curvilinear pattern 912. Any combination of arrangements of the microprint characters 904 may be used and the microprint characters may overlap and/or form intertwining strings. Furthermore, in some examples, the microprint characters 904 may be printed in varying sizes, orientations, fonts, or weights (i.e., some bold, others not). In still further examples, the microprint characters 904 may be combined with solid or broken lines to form the border 902.

The microprint characters 904 may also form a cornice(s) 920 in one or more of the corners of the border 902. The cornice 920 may be formed with one or more of the microprint styles described herein. Furthermore, in some examples, the cornice 920 includes a blank 922, which is a portion of the cornice 920 that lacks or substantially lacks the microprint characters 904. Some blanks 922 may be formed or preserved by using partial or incomplete letters in the microprint 904 in the area adjacent to the blank 922.

When the example security document 900 is reproduced by a digital imaging device or otherwise scanned or copied, at least a portion of the microprint characters 904 are not substantially reproducible and drop out partially or fully. Additionally or alternatively, in some examples, at least some of the microprint characters 904 darken, blur or otherwise become unclear when reproduced by a digital imaging device or are otherwise scanned or copied. Furthermore, the copy of the security document 900 would not include a legible border 902, and the copy would have an image file size (i.e., a lower amount of data) that is less than that of the original security document 900. Thus, a copy, counterfeit document or otherwise unauthorized security document or archive version could be identified based on the file size, where the file size of an original, true authorized copy is known.

In some examples, the border 902 may be comprised exclusively of microprint characters 904. Furthermore, the microprint characters 904 may provide an indication that the border 902 is exclusively microprint characters 904. For example, the microprint characters 904 may spell out a phrase such as, for example, “microprint only” or “all microprint.” Thus, in instances in which some of the microprint appeared to be a solid line when copied, a copy could be identified if the border 902 includes a combination solid lines and microprint that spells out “microprint only.” In addition, in other examples, the border 902 may be of another composition and the microprint 904 may provide an indication of that composition.

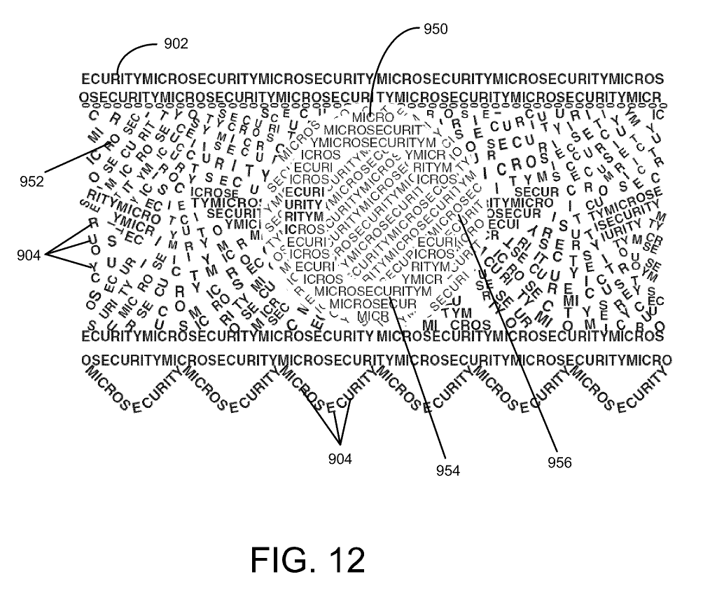

The microprint characters 904 may also be used to form one or more latent letters 950 as shown in the example security border of FIG. 12. As shown in FIG. 12, the border 902 comprises a first pattern of microprint 952 (“first pattern” in this example does not necessarily mean one, single pattern but, rather, the general border 902 of microprint characters 904 regardless of their orientation). Within the border 902 is a second pattern of microprint characters 954 that form the shape of a letter, i.e., the latent letter 950. In this example, the latent letter is the Latin letter ‘C’. However, in other examples, the latent letter may be any other letter, multiple letters, a word, any language, symbol, trademark or other indicia including machine-readable indicia.

In the example of FIG. 12, the second pattern of microprint 954 is offset from the first pattern of microprint 952 by an underlying third pattern of microprint 956. In other examples, the third pattern of microprint 956 may be omitted and the second pattern of microprint 954 may overlie the first pattern of microprint 952 or a blank (e.g., the blank 922 of FIGS. 10 and 11). Furthermore, in this example, the second and third patterns of microprinting 954, 956 include microprint characters that vary in one or more of size, spacing or orientation from the microprint characters of the first pattern of microprint 952 and/or to each other. However, any of the other microprint styles described herein may be used additionally or alternatively.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A security document comprising: a border formed at least partially by a plurality of microprint characters, wherein at least a portion of the microprint characters are arranged in a curvilinear pattern, and wherein at least a portion of the microprint characters are not substantially reproducible via a digital imaging device.

2. A security document as described in claim 1, wherein all of the microprint characters are not substantially reproducible via a digital imaging device.

3. A security document as described in claim 1, wherein at least a portion of the microprint characters darken when reproduced via a digital imaging device.

4. A security document as described in claim 1, wherein the border comprises only microprint characters.

5. A security document as described in claim 4, wherein the microprint characters provide an indication that the border comprises only microprint characters.

6. A security document as described in claim 1, wherein at least a first portion of the microprint characters overlap a second portion of the microprint characters.

7. A security document as described in claim 1, wherein the border further comprises solid lines.

8. A security document as described in claim 1, wherein at least a portion of the microprint characters are incomplete.

9. A security document as described in claim 1 further comprising a three-dimensional pantograph.

10. A security document as described in claim 1, wherein at least a portion of the microprint characters vary in size and orientation.

11. A security document as described in claim 1, wherein the microprint characters of the border form a first pattern and the border further comprises one or more latent letters formed by a second pattern of microprint characters.

12. A security document as described in claim 11, wherein the second pattern of microprint characters overlies a third pattern of microprint characters.

13. A security document as described in claim 12, wherein the second and third patterns include microprint characters that vary in one or more of size, spacing or orientation from the microprint characters of the first pattern.

14. A security document as described in claim 1, wherein the border further comprises cornices formed by at least a portion of the microprint characters.

15. A security document as described in claim 1, wherein a first portion of the microprint characters is arranged at multiple angles with respect to one or more other portions of the microprint characters.

16. A border for a security document comprising:
a plurality of strings of microprint text, wherein at least a portion of the at least some of the plurality of strings of microprint text is arranged in a curvilinear manner.

17. A border for a security document as defined in claim 16, wherein at least a portion of some of the plurality of the strings of microprint text overlap at least a portion of other of the plurality of strings of microprint text.

18. A border for a security document as defined in claim 16, wherein at least a portion of the plurality of strings of microprint text intertwine.

19. A border for a security document as defined in claim 16, wherein at least a portion of the microprint text indicates the composition of the border.

20. A border for a security document as defined in claim 16, wherein a portion of the microprint text is not substantially reproducible when copied via a digital imaging device and a portion of the microprint text darkens when copied via a digital imaging device.
